(19) United States
(12) Patent Application Publication
(10) Pub. No.: US 2009/0155628 A1
(43) Pub. Date: Jun. 18, 2009

(54) MAGNETIC THIN FILM STRUCTURE, MAGNETIC RECORDING MEDIUM INCLUDING THE SAME, AND METHOD OF MANUFACTURING THE MAGNETIC RECORDING MEDIUM

(75) Inventors: Myung-bok LEE, Suwon-si (KR); Jin-seung SOHN, Seoul (KR); Seong-yong YOON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/106,852

(22) Filed: Apr. 21, 2008

(30) Foreign Application Priority Data
Dec. 14, 2007 (KR) 10-2007-0131050

(51) Int. Cl. G11B 5/66; G11B 5/84

(52) U.S. Cl. 428/828; 428/832; 427/132

(57) ABSTRACT

A magnetic thin film structure, a magnetic recording medium including the same, and a method of manufacturing the magnetic recording medium are provided. The magnetic recording medium includes an under layer formed of a transition metal nitride on a substrate and a plurality of magnetic dots, which are unit recording regions, formed of a magnetic material having magnetic anisotropy energy between 10⁶ erg/cc and 10⁸ erg/cc.

### CROSS-REFERENCE TO RELATED PATENT APPLICATION

This application claims the benefit of Korean Patent Application No. 10-2007-0131050, filed on Dec. 14, 2007, in the Korean Intellectual Property Office, the disclosure of which is incorporated herein in its entirety by reference.

### BACKGROUND OF THE INVENTION

1. Field of the Invention

The present invention relates to a magnetic thin film structure, a magnetic recording medium including the same, and a method of manufacturing the magnetic recording medium, and more particularly, to a magnetic thin film structure formed of a material having high magnetic anisotropy energy, a magnetic recording medium including a plurality of magnetic dots, each of which is a unit recording region formed of the magnetic thin film structure, and a method of manufacturing the magnetic recording medium.

2. Description of the Related Art

Recently, the demand for information recording devices capable of recording and reproducing information in higher density is increasing due to the large quantities of data in circulation. In particular, magnetic recording devices using magnetic recording media are used as information recording devices for computers and various other digital devices, because the magnetic recording devices can utilize a large recording capacity and have fast access speeds.

A magnetic recording medium is formed of magnetic layers having continuous crystal structures on a substrate. The magnetic recording medium stores information by magnetizing each of the crystals in a uniform orientation to apply data signals of logic ‘0’ and logic ‘1’ thereto. In such magnetic recording medium, the size of each crystal is reduced to store more information. However, if the size of each crystal is reduced below a certain limit, the magnetic recording medium can no longer maintain stability as an information recording medium due to instability based on a superparamagnetic limit. Moreover, a signal-noise ratio (SNR) decreases. If a signal magnetic field emitted from a magnetic recording medium decreases, the magnetic recording device cannot detect information required by a user of the magnetic recording device.

A patterned magnetic recording medium is produced by physically patterning nano-sized magnetic dots in advance such that each of a plurality of recording bit regions is not a cluster of tiny crystal grains but is an independent dot pattern, and by magnetizing each of the patterned dots in a uniform orientation to record data values of ‘0’ and ‘1’ in the bits A patterned magnetic recording medium can overcome conventional problems regarding the superparamagentic limit and a low SNR and can increase recording capacity.

Meanwhile, as the recording density of magnetic recording mediums increases, the size of a region in which a minimum unit of information is recorded, that is, the size of a bit, is reduced so that a nano-sized dot pattern is formed. Since the dots may be thermally unstable if they are too small and highly integrated, a technology for forming the dots of a material having high magnetic anisotropy energy is required.

### SUMMARY OF THE INVENTION

The present invention provides a magnetic thin film structure capable of securing high magnetic anisotropy energy, a magnetic recording medium in which dots are formed of a material with high magnetic anisotropic energy to be small and thermally stable, and a method of manufacturing the magnetic recording medium.

According to an aspect of the present invention, there is provided a magnetic thin film structure including an under layer formed of a transition metal nitride and a magnetic layer having a L1₀ structure and formed on the under layer.

According to another aspect of the present invention, there is provided a magnetic recording medium including a substrate, a under layer formed of a transition metal nitride and disposed on the substrate, and a magnetic recording layer which includes a plurality of dots, formed of a magnetic material having magnetic anisotropy, includes a non-magnetic region separating the dots, formed of a material different from the magnetic material of the dots, and is disposed on the under layer.

According to another aspect of the present invention, there is provided a method of method of manufacturing a magnetic recording medium including forming an under layer of a transition metal nitride on a substrate, forming a mold layer on the under layer, patterning the mold layer to expose the under layer between patterns, forming dots by disposing a magnetic material on portions of the under layer exposed between the patterns, and heat treating the dots in order for the dots to have a L1₀ structure.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view roughly illustrating a structure of a magnetic recording medium according to an embodiment of the present invention;

FIGS. 2A through 2G are sectional views illustrating a method of manufacturing a magnetic recording medium, according to an embodiment of the present invention; and

FIG. 3 is a timing diagram of voltage signals applied when magnetic dots are being formed in a magnetic recording layer illustrated in FIG. 2F, according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements, and thus their description will be omitted.

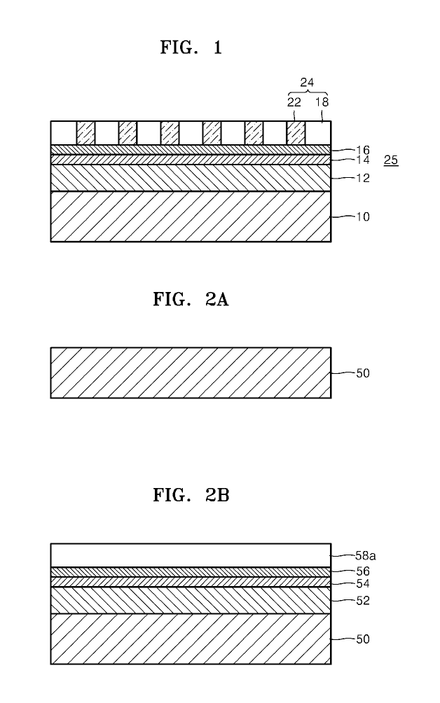

FIG. 1 is a sectional view roughly illustrating a structure of a magnetic recording medium 25 according to an embodiment of the present invention. The magnetic recording medium 25 illustrated in FIG. 1 is an example of a magnetic thin-film structure used as a medium for magnetic recording.

Referring to FIG. 1, the magnetic recording medium 25 according to the current embodiment of the present invention includes a substrate 10 formed of a non-magnetic material, and a magnetic recording layer 24 including a plurality of dots 22 and a non-magnetic region 18 between the dots 22. The magnetic recording medium 25 further includes a soft magnetic layer 12, an intermediate layer 14, and an under layer 16 disposed between the substrate 10 and the magnetic recording layer 24. Also, a protective layer (not shown), protecting the magnetic recording layer 24, and a lubricating layer (not shown), reducing abrasion of a magnetic head (not shown) and the protective layer caused by collision with a magnetic head or by sliding, may be further disposed on the magnetic recording layer 24.

The substrate 10 may be a glass substrate, an aluminium alloy substrate, or a silicon substrate, and is usually formed in the shape of a disk.

The soft magnetic layer 12 induces a magnetic flux emitted from the magnetic head to form a magnetic field in the magnetic recording medium 25 so that the magnetic recording layer 24 can be effectively magnetized. The soft magnetic layer 12 may be formed of one of CoZrNb, CoFeZrNb, NiFe, NiFeMo, and CoFeNi, and the thickness of the soft magnetic layer 12 may be between 10 nm and 200 nm. The crystalline structure of the soft magnetic layer 12 may be crystalline or amorphous. The soft magnetic layer 12 may be formed to have a multi-layer structure.

The intermediate layer 14 prevents the crystallinity of the soft magnetic layer 12 affecting the crystallinity of the magnetic recording layer 24, and may be formed of insulating materials such as SiO₂, Si₃N₄, Al₂O₃, etc. The crystalline structure of the intermediate layer 14 may be amorphous.

The dots 22 of the magnetic recording layer 24 are unit recording regions. The magnetic recording layer 24 also includes non-magnetic regions 18 separating the dots 22. The dots 22 in the magnetic recording region 24 are formed to be nano-sized for high recording density. However, since their small sizes may cause thermal instability, the dots 22 are formed of a magnetic material having high magnetic anisotropy energy. The magnetic material forming the dots 22 may be formed in ordered phase of a L1₀ structure, and thus the dots 22 may have a magnetic anisotropy energy in a range of 10⁶ to 10⁸ erg/cc. The magnetic material may include at least one of Fe, Co, and Pt. The dots 22 may be formed of FePt or CoPtor may include at least one of FePt, FePd, CoPt, and CoPd, which have the L1₀ structures. The non-magnetic region 18 may be formed of a material different from the magnetic materials described above. In this regard, the non-magnetic region 18 may be formed of an insulation material, and more particularly, an insulation material such as SiO₂, Si₃N₄, Al₂O₃, or resin.

The under layer 16 is disposed between the magnetic recording layer 24 and the intermediate layer 14. The under layer 16 may be formed of a transition metal nitride, which is a non-magnetic material. In this regard, the under layer 16 may include at least one of TiN, ZrN, HfN, VN, TaN, CrN, ScN, Mo₂N, and W₂N.

Since a transition metal nitride has high electrical conductivity, the under layer 16 may function as a seed layer when the magnetic recording layer 24 is being formed. Also, the under layer 16 affects the crystalline structure of a material forming the dots 22 in the magnetic recording layer 24 as described below. Since a transition metal nitride has a characteristic of a diffusion barrier, the under layer 16 prevents elements in the dots 22 and elements in the soft magnetic layer 12 from mutually diffusing during a post annealing of the magnetic recording layer 24.

The top crystal surface of the under layer 16 may have a (001) vertical orientation. The crystal surfaces of the under layer 16 may have lattice mismatches with the magnetic recording layer 24 and, especially, the crystal surfaces of the dots 22. (001) surfaces of the dots 22 cause a C-axis strain in the L1₀ phase. Due to the lattice mismatches, a strain energy works as a driving force, and an ordering temperature of the magnetic material forming the dots 22 may be lowered.

Table 1 is a table of lattice parameters of transition metal nitrides and values of lattice mismatches with the transition metal nitrides when the dots 22 of the magnetic recording layer 24 are formed of FePt or CoPt in the L1₀ phase.

TABLE 1

| | Crystal | Lattice | Lattice Mismatches with |
|---|---|---|---|
| Nitrides | Structure | Parameter (Å | FePt in L1₀ phase (%), ε |
| TiN | NaCl | 4.249 | 9.34 |
| ZrN | NaCl | 4.537 | 15.1 |
| HfN | NaCl | 4.50 | 14.4 |
| VN | NaCl | 4.136 | 6.87 |
| TaN | NaCl | 4.344 | 11.3 |
| CrN | NaCl | 4.148 | 7.14 |
| ScN | NaCl | 4.45 | 13.4 |
| Mo₂N | NaCl | 4.168 | 7.58 |
| W₂N | NaCl | 4.128 | 6.69 |
| MgO | NaCl | 4.2112 | 8.53 |
| FePt | L1₀ | a = 3.852 | — |
| | | c = 3.713 | |
| CoPt | L1₀ | a = 3.812 | — |
| | | c = 3.695 | |

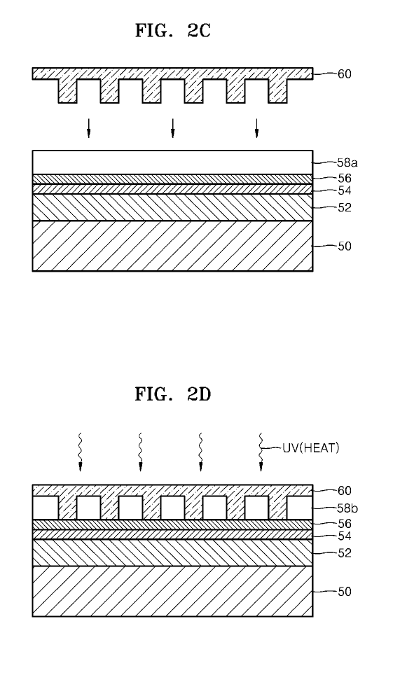

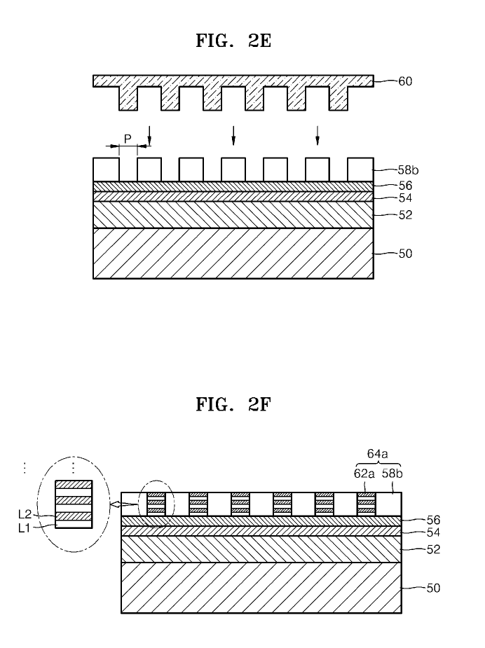

FIGS. 2A through 2G are sectional views illustrating a method of manufacturing a magnetic recording medium, according to an embodiment of the present invention.

Referring to FIG. 2A, a substrate 50 is prepared. Referring to FIG. 2B, a soft magnetic layer 52 formed of CoZrNb is formed on the substrate 50, and an intermediate layer 54 formed of SiO₂, an under layer 56 formed of TiN, and a mold layer 58a formed of resin for imprinting are formed in sequence on the soft magnetic layer 52. A pattern is then formed on the mold layer 58a. FIGS. 2C through 2E illustrate a method of patterning the mold layer 58a by using a nano imprinting method using a master 60. The master 60 is formed to have a uneven pattern of a reversed image on the bottom surface thereof. Referring to FIG. 2C, the master 60 is disposed on top of the mold layer 58a, and pressure is applied to the master 60 to transfer the pattern of the master 60 to the mold layer 58a, thereby forming a patterned mold layer 58b. Referring to FIG. 2D, the resin forming the patterned mold layer 58b is then hardened by using ultraviolet rays or heat. Referring to FIG. 2E, the master 60 is removed thereafter. The thickness of the patterned mold layer 58b may be between dozens of nm and hundreds of nm. The pattern transferred from the master 60 may have a diameter of dozens of nm. For an example, the patterns have a pitch of 4 nm to 10 nm. The master 60 may be formed using various methods used in nano-patterning such as an electron beam lithography method, a near-field light lithography method, an ion beam lithography method, a laser interference lithography method, etc.

Although nano imprinting methods have been described as being used in the patterning of the mold layer 58a in FIGS. 2C through 2E, the present invention is not limited thereto. For example, the patterned mold layer 58b may be formed by using either a lithography method or an anodic aluminium oxidization (AAO) method. If the patterned mold layer 58b is patterned using a lithography method, the non-magnetic region 18 may be formed of one of SiO₂, Si₃N₄, and Al₂O₃. Also, if the patterned mold layer 58b is patterned by using the AAO method, the non-magnetic region 18 may be formed of aluminium.

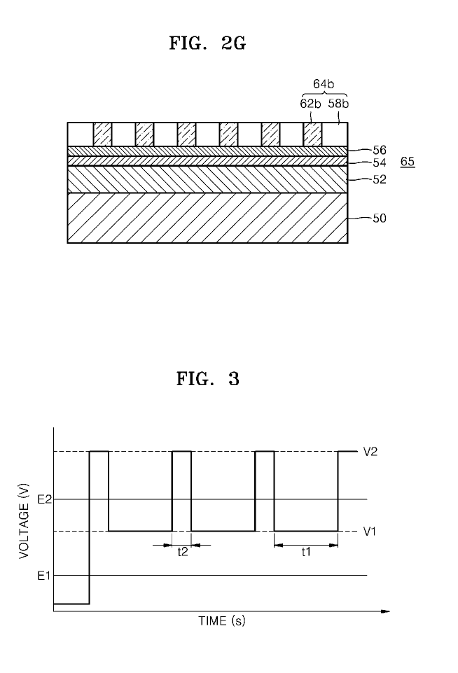

Referring to FIG. 2F, dots 62a are formed on the portions of the under layer 56 exposed between the patterns of the patterned mold layer 58b. The dots 62a are formed by stacking a plurality of Fe L1 layers and a plurality of Pt L2 layers alternately by using an electroplating method. The Fe and the Pt may also be stacked in reversed order. An electrolyte used in the electroplating method is a mixture of 0.12 mol/l of FeSO₄.7H₂O, 0.01 mol/l of H₂PtCl₆.6H₂O, 0.45 mol/l of Na₄P₂O₇.10H₂O, and 0.05 mol/l of NaH₂PO₂.H₂O. The electrolyte has a pH of 8.4 and the temperature of the electrolyte is 40° C. The electroplating method used may be a pulse electroplating method, forming Fe/Pt by alternately extracting Fe and Pt to form the Fe/Pt layers alternately stacked. FIG. 3 is a timing diagram of voltage signals applied when the dots 62a are being formed, according to an embodiment of the present invention.

In FIG. 3, E1 represents a decomposition voltage for extracting Pt, while E2 represents a decomposition voltage for extracting Fe. Referring to FIG. 3, since the decomposition voltages E1 and E2 for respectively extracting Pt and Fe are different from each other, it is possible to extract only one of the metals by setting pulse voltages V1 and V2 different from each other when performing the electroplating. Also, the thickness of the Fe and Pt layers can be controlled by adjusting the durations of the pulses.

Referring back to FIG. 2F, although the dots 62a may be formed by stacking Fe and Pt layers alternately using an electroplating method, the dots 62a may also be formed by using a sputtering method or a chemical vapor decomposition method, or by alternately stacking more than two materials each including at least one of Fe, Co, and Pt.

Referring to FIG. 2G, dots 62b each of which has a single FePt layer and the L1₀ structure are formed by heat treating the dots 62a each of which has a plurality of alternate Fe and Pt layers. The heat treatment temperature may be between 200° C. and 400° C. Although the FePt layers need to be heat-treated for a long time at a temperature above 700° C. to be crystallized in the L1₀ structure, Fe and Pt has shorter distance of mutual diffusion for crystallization in a layer structure of the plurality of the alternate Fe and Pt layers, and thus diffusion driving force is lowered and the heat treatment temperature may be lowered. As the heat treatment temperature is lowered, the risk of destruction of layer structure due to mutual diffusion of layers other than the alternate Fe and Pt layers or destruction of patterns of the dots 62b, may be reduced. The magnetic recording medium and the method of manufacturing the same described above are merely embodiments of a magnetic thin film structure and a method of manufacturing the same. In other words, the soft magnetic layer and the intermediate layer are layers improving magnetic recording and playback characteristics of the magnetic recording medium, and do not limit the scope of the present invention. The magnetic thin film structure according to the present invention has a structure in which a magnetic layer having high magnetic anisotropy is formed on an under layer by forming the under layer using a transition metal nitride, and may be applied to a micro electro mechanical system (MEMS) or a nano electro mechanical system (NEMS), which require a magnetic thin film structure having high magnetic anisotropy, other than a magnetic recording medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A magnetic recording medium comprising:
a substrate;
an under layer disposed on the substrate and formed of a transition metal nitride;
a magnetic recording layer disposed on the under layer and comprising a plurality of dots formed of a magnetic material having high magnetic anisotropy energy, and a non-magnetic region between the dots, formed of a material different from the magnetic material.

2. The magnetic recording medium of claim 1, wherein the magnetic material forming the dots has a L1₀ structure.

3. The magnetic recording medium of claim 2, wherein a top crystal surface of the under layer facing the magnetic recording layer is a (001) surface.

4. The magnetic recording medium of claim 3, wherein the under layer has a lattice mismatch of 5 to 15% against the magnetic recording layer.

5. The magnetic recording medium of claim 1, wherein the transition metal nitride comprises at least one of TiN, ZrN, HfN, VN, TaN, CrN, ScN, Mo₂N, and W₂N.

6. The magnetic recording medium of claim 1, wherein the magnetic material forming the dots has a magnetic anisotropy energy between 10⁶ erg/cc and 10⁸ erg/cc.

7. The magnetic recording medium of claim 1, wherein the magnetic material comprises at least one of Fe, Co, and Pt.

8. The magnetic recording medium of claim 1, further comprising a soft magnetic layer interposed between the substrate and the under layer.

9. The magnetic recording medium of claim 8, further comprising an intermediate layer interposed between the soft magnetic layer and the under layer.

10. The magnetic recording medium of claim 9, wherein the intermediate layer is formed of an insulating material.

11. The magnetic recording medium of claim 9, wherein the intermediate layer is formed of one of resin, SiO₂, SiN, and Al₂O₃.

12. A method of manufacturing a magnetic recording medium, comprising:
forming an under layer of a transition metal nitride on a substrate;
forming a mold layer on the under layer;
patterning the mold layer to expose the under layer between patterns;
forming dots by disposing a magnetic material on portions of the under layer exposed between the patterns; and
heat treating the dots in order for the dots to have a L1₀ structure.

13. The method of claim 12, wherein the transition metal nitride is one of TiN, ZrN, HfN, VN, TaN, CrN, ScN, Mo₂N, and W₂N.

14. The method of claim 12, wherein a top crystal surface of the under layer is formed to have a (001) surface.

15. The method of claim 12, further comprising forming a soft magnetic layer and an intermediate layer on the substrate in sequence prior to the forming of the under layer.

16. The method of claim 12, wherein the patterns have a pitch of 4 nm to 10 nm.

17. The method of claim 12, wherein the patterning of the mold layer to expose the under layer between the patterns is performed using a nano imprinting method, a lithography method, or an anodic aluminium oxidization (AAO) method.

18. The method of claim 12, wherein the forming of the dots by disposing the magnetic material on the portions of the under layer exposed between the patterns is performed using an electroplating method to stack a layer comprising at least one of Fe, Co, and Pt.

19. The method of claim 12, wherein the forming of the dots by disposing the magnetic material on the portions of the under layer exposed between the patterns is performed using an electroplating method to stack more than two layers comprising at least one of Fe, Co, and Pt alternately.

20. The method of claim 12, wherein the forming of the dots by disposing the magnetic material on the portions of the under layer exposed between the patterns is performed by forming alternate Fe and Pt layers using an electroplating method.

21. The method of claim 12, wherein the heat treatment is performed at a temperature between 200° C. and 400° C.

22. A magnetic thin film structure comprising:
an under layer formed of a transition metal nitride; and
a magnetic layer having a L1₀ structure and formed on the under layer.

23. The magnetic thin film structure of claim 22, wherein a top crystal surface of the under layer facing the magnetic layer is a (001) surface, and has a lattice mismatch of 5 to 15% against the magnetic layer.

24. The magnetic thin film structure of claim 22, wherein the transition metal nitride is one of TiN, ZrN, HfN, VN, TaN, CrN, ScN, Mo₂N, and W₂N.

25. The magnetic thin film structure of claim 22, wherein the magnetic layer is formed of a magnetic material comprising at least one of Fe, Co, and Pt.
